(19) United States
(12) Patent Application Publication
(10) Pub. No.: US 2014/0306867 A1
(43) Pub. Date: Oct. 16, 2014

(54) PIXEL CIRCUIT, DRIVING METHOD THEREFOR AND DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Haigang Qing, Beijing (CN); Xiaojing Qi, Beijing (CN)

(73) Assignees: BOE TECHNOLOGY GROUP CO., LTD., Beijing (CN); CHENGDU BOE OPTOELECTRONICS TECHNOLOGY CO., LTD., Chengdu, Sichuan (CN)

(21) Appl. No.: 14/235,961

(22) PCT Filed: Jun. 13, 2013
(86) PCT No.: PCT/CN2013/077166

§ 371 Date: Jan. 29, 2014

(30) Foreign Application Priority Data
Apr. 15, 2013 (CN) 201310129993.8

(51) Int. Cl. G09G 3/32

(52) U.S. Cl. CPC G09G 3/3216
USPC 345/76

(57) ABSTRACT

Provided are a pixel circuit, a driving method for the pixel circuit and a display device including the pixel circuit. In the pixel circuit, when the data is written to the storage capacitor, the threshold voltage of the driving transistor and the data voltage are pre-stored in the storage capacitor by means of a diode connection formed by the driving transistor, so that the drift of the threshold voltage can be compensated effectively, and thus the uniformity and the stability of the driving current are maintained. Further, in the embodiment of the present disclosure, the scan signal for the pixel circuit is multiplexed in the touch circuit, and the coupling capacitor in the touch circuit is charged simultaneously while the storage capacitor is charged, and thus, the integration of the touch circuit into the pixel circuit can be realized perfectly without increasing the complexity of the circuit structure and the operation thereof.

### TECHNICAL FIELD

The present disclosure relates to a field of organic light-emitting display technology, particularly to a pixel circuit, a driving method for the pixel circuit and a display device comprising the pixel circuit.

### BACKGROUND

Compared to conventional liquid crystal panels, an Active Matrix Organic Light Emitting Diode (AMOLED) panel has characteristics such as a faster response speed, a higher contrast, and a wider view angle and the like. Thus, AMOLED has gained an increasing attention of developers of display devices.

The AMOLED is driven via a pixel circuit to emit light. A conventional 2T1C pixel circuit comprises two Thin Film Transistors (TFTs) and one capacitor (C), and is particularly illustrated in FIG. 1, the pixel circuit comprises a driving transistor DTFT, a switching transistor T5′ and a storage capacitor Cₛₜ, wherein the switching transistor T5′ is controlled by a scan signal V_{scan} to control an input of a data voltage V_{data}, the driving transistor DTFT controls an OLED to emit light, and the storage capacitor Cₛₜ supplies a maintaining voltage to a gate of the driving transistor DTFT.

FIG. 2 shows a driving timing diagram of the 2T1C pixel circuit illustrated in FIG. 1. The operational process of the 2T1C pixel circuit is as follows: when the scan signal is at a low level, the switching transistor T5′ is turned on, and the storage capacitor Cₛₜ is charged by a grayscale voltage (a data voltage V_{data}) on a data line; meanwhile, the data voltage V_{data} is applied to the gate of the driving transistor DTFT, so that the driving transistor DTFT operates in a saturation state to drive the OLED to emit light; when the scan signal is at a high level, the switching transistor T5′ is turned off, and the storage capacitor Cₛₜ supplies the maintaining voltage to the gate of the driving transistor DTFT, so that the driving transistor DTFT still operates in a saturation state to drive the OLED to emit light continuously.

It can be known from the above, the OLED in the AMOLED panel can be driven to emit light by a driving current generated by the driving transistor DTFT in the saturation state. Specifically, the driving current (flowing through an circuit in which OLED is located) I_{OLED}=K(V_{sg}−|V_{thd}|)², wherein V_{sg} represents a voltage difference between the gate and a source of the driving transistor DTFT, |V_{thd}| represents a threshold voltage of the driving transistor DTFT, K represents a constant concerning the structure and technical process of the driving transistor DTFT itself. Since in an existing low temperature poly-silicon manufacturing process, the uniformity of the threshold voltages Vth of TFTs is poor, and the threshold voltages may drift in operation, and thus even if a same data voltage V_{data} is input to the respective driving transistors DTFT, different driving currents are generated due to different threshold voltages of the driving transistors DTFT, so that the uniformity of the luminance of the AMOLED panel is poor.

In recent years, a touch function is widely used in various display panels especially in mobile displays, and nearly becomes a standard configuration of a smart phone. In the prior art, a display panel and a Touch Screen Panel (TSP) are manufactured separately, and then are bonded together. Such a technical process flow brings about a complex technical process and high cost of a functional panel in a display touch panel, and has adversely affected the lightness and thinness of the displays. The technique of TSP in cell integrates the display function with the touch function, and can utilize one technical process flow rather than two separate technical flows to realize the combination of the display function and the touch function. Therefore, the technique of TSP in cell not only has an advantage of low cost, but also brings about a simple technical process, and results in a lighter and thinner display touch panel. However, at present, there is no a better solution to the problem how to integrate a touch circuit with a pixel circuit perfectly.

### SUMMARY

Embodiments of the present disclosure aim to provide a pixel circuit which can compensate a drift of a threshold voltage of a driving transistor, so as to improve the uniformity of the luminance of an OLED display panel; further, in the embodiments of the present disclosure, a touch circuit is integrated into the pixel circuit perfectly without increasing the complexity of a circuit structure and an operation thereof.

In the embodiments of the present disclosure, there is further provided a driving method for driving the above pixel circuit and a display device comprising the pixel circuit described as above, thus improving the display quality of the display device.

According to an embodiment of the present disclosure, there is provided a pixel circuit comprising an electroluminescent element, a driving transistor, a first switching unit, a compensating unit, an isolating unit and a storage capacitor, wherein

the first switching unit controls to input a data voltage on a data line, and a first terminal of the first switching unit is connected to a first terminal of the storage capacitor, a second terminal of the first switching unit is connected to the data line;

a second terminal of the storage capacitor is connected to a gate of the driving transistor and a first terminal of the compensating unit;

the compensating unit controls the storage capacitor to pre-store a threshold voltage of the driving transistor, and a second terminal of the compensating unit is connected to a drain of the driving transistor;

a source of the driving transistor is connected to a power supply terminal, and the drain of the driving transistor is connected to a first terminal of the electroluminescent element;

the isolating unit isolates an electrical connection between the electroluminescent element and a grounded terminal, wherein a first terminal of the isolating unit is connected to a second terminal of the electroluminescent element, and a second terminal of the isolating unit is connected to the grounded terminal.

In an example, the electroluminescent element is an Organic Light Emitting Diode, the first switching unit is a first switching transistor, the compensating unit is a compensating transistor, and the isolating unit is an isolating transistor;

a gate of the first switching transistor is connected to a first scan signal terminal, a source thereof is connected to the first terminal of the storage capacitor, a drain thereof is connected to the data line;

the second terminal of the storage capacitor is connected to the gate of the driving transistor and a drain of the compensating transistor;

a gate of the compensating transistor is connected to a first control signal terminal, a source thereof is connected to a drain of the driving transistor;

the source of the driving transistor is connected to the power supply terminal, the drain of the driving transistor is connected to an anode of the OLED;

a gate of the isolating transistor is connected to a second control signal terminal, a source thereof is connected to a cathode of the OLED, and a drain thereof is connected to the grounded terminal.

In an example, the pixel circuit further comprises a resetting transistor, wherein a gate of the resetting transistor is connected to the source of the isolating transistor, a source of the resetting transistor is connected to the first terminal of the storage capacitor, and a drain thereof is connected to the second control signal terminal.

In an example, the pixel circuit is further connected to a touch circuit, wherein the touch circuit comprises a charging transistor, a coupling capacitor, a sensing electrode, an amplifying transistor and a second switching transistor, a second scan signal terminal and a sensing line;

wherein a gate of the charging transistor is connected to a third control signal terminal, a source thereof is connected to the second terminal of the storage capacitor, a drain thereof is connected to the sensing electrode;

a first terminal of the coupling capacitor is connected to the sensing electrode, and a second terminal thereof is connected to the second scan signal terminal;

a gate of the amplifying transistor is connected to the sensing electrode, a source thereof is connected to the power supply terminal, a drain thereof is connected to a source of the second switching transistor;

a gate of the second switching transistor is connected to the second scan signal terminal, and a drain thereof is connected to the sensing line.

In an example, the third control signal terminal is the first scan signal terminal.

In an example, all of the transistors have a same type of channel.

In an embodiment of the present disclosure, there is further provided a driving method for driving the above pixel circuit, wherein the driving method comprises steps of:

S1, applying a scan signal at the first scan signal terminal and applying a control signal at the first control signal terminal to turn on the first switching transistor and the compensating transistor, and applying a control signal at the second control signal terminal to turn off the isolating transistor, so as to write the threshold voltage of the driving transistor and the data voltage on the data line to the storage capacitor;

S2, applying a scan signal at the first scan signal terminal and applying a control signal at the first control signal terminal to turn off the first switching transistor and the compensating transistor, and applying a control signal at the second control signal terminal to turn on the isolating transistor, so as to drive the OLED to emit light using the voltage stored in the storage capacitor.

In an example, prior to the step S1, the method further comprises:

applying a scan signal at the first scan signal terminal to turn off the first switching transistor, applying control signals at the first control signal terminal and the second control signal terminal respectively to turn on the compensating transistor, the isolating transistor, and the resetting transistor so as to reset the storage capacitor.

In an example, the step S1 further comprises: applying a scan signal at the first scan signal terminal to turn on the charging transistor, and applying a scan signal at the second scan signal terminal to turn off the second switching transistor, so as to charge the coupling capacitor by the power supply terminal via the driving transistor and the charging transistor;

the step S2 further comprises: applying a scan signal at the first scan signal terminal to turn off the charging transistor, applying a scan signal at the second scan signal terminal to turn on the second switching transistor, and monitoring a variation of a current on the sensing line.

In an embodiment of the present disclosure, there is further provided a display device comprising any of the pixel circuits as above.

In the pixel circuit provided in the embodiments of the present disclosure, when the data voltage is written to the storage capacitor, the threshold voltage of the driving transistor and the data voltage are pre-stored in the storage capacitor by means of a diode connection formed by the driving transistor, so that the drift of the threshold voltage can be compensated effectively, and thus the uniformity and the stability of the driving current are maintained. Further, in the embodiment of the present disclosure, the scan signal for the pixel circuit is multiplexed in the touch circuit, and the coupling capacitor in the touch circuit is charged simultaneously while the storage capacitor is charged, and thus, the integration of the touch circuit into the pixel circuit can be realized perfectly without increasing the complexity of a circuit structure and an operation thereof.

### BRIEF DESCRIPTION OF THE DRAWINGS

FIG. 1 is a schematic structure diagram of a pixel circuit in the prior art;

FIG. 2 is a driving timing diagram of the pixel circuit shown in FIG. 1;

FIG. 3 is a schematic block diagram of a pixel circuit according to a first embodiment of the present disclosure;

FIG. 4 is a schematic structure diagram of the pixel circuit according to the first embodiment of the present disclosure;

FIG. 5 is a driving timing diagram of the pixel circuit shown in FIG. 4;

FIG. 6 is a schematic diagram of an equivalent circuit structure of the pixel circuit shown in FIG. 4 during a period t₁;

FIG. 7 is a schematic diagram of an equivalent circuit structure of the pixel circuit shown in FIG. 4 during a period t₂;

FIG. 8 is a schematic diagram of an equivalent circuit structure of the pixel circuit shown in FIG. 4 during a period t₃;

FIG. 9 is a schematic diagram of an equivalent circuit structure of the pixel circuit shown in FIG. 4 during a period t₄;

FIG. 10 is a schematic structure diagram of a pixel circuit according to a second embodiment of the present disclosure;

FIG. 11 is a driving timing diagram of the pixel circuit shown in FIG. 10;

FIG. 12 is a schematic diagram of an equivalent circuit structure of the pixel circuit shown in FIG. 10 during a period t₁;

FIG. 13 is a schematic diagram of an equivalent circuit structure of the pixel circuit shown in FIG. 10 during a period t₂;

FIG. 14 is a schematic diagram of an equivalent circuit structure of the pixel circuit shown in FIG. 10 during a period t₃; and

FIG. 15 is a schematic diagram of an equivalent circuit structure of the pixel circuit shown in FIG. 10 during a period t₄.

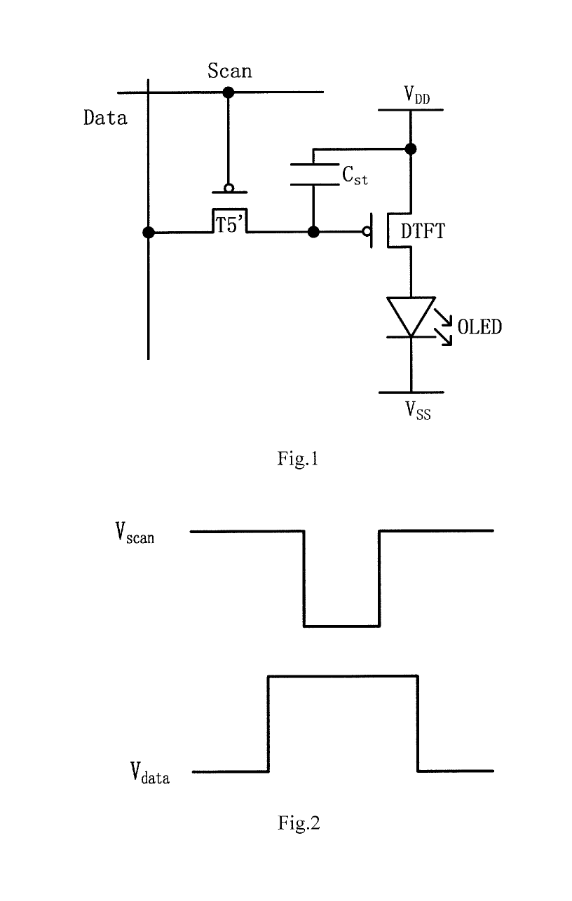

### DETAILED DESCRIPTION OF THE PREFERRED EMBODIMENTS

A detailed description will be given to specific implementations of embodiments of the present disclosure with reference to accompanying drawings. The following embodiments only illustrate the principle of the present disclosure, but do not limit the scope of the present disclosure in any way.

### First Embodiment

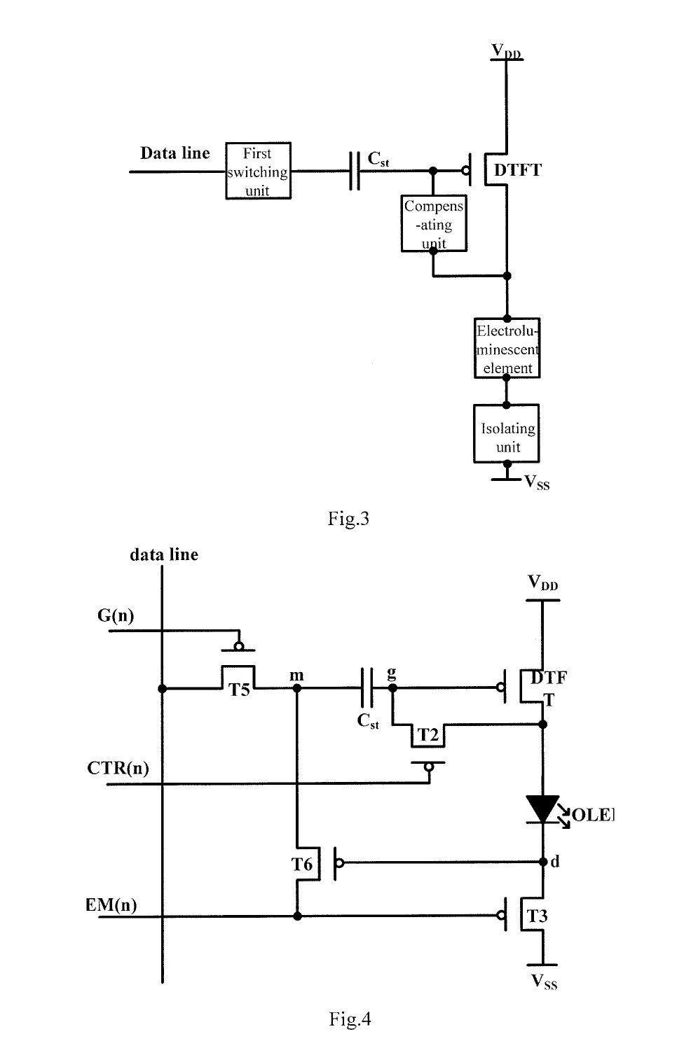

In the present embodiment, a structure of a pixel circuit in an OLED display comprising OLEDs having a common cathode is taken as an example for illustration. As illustrated in FIG. 3, the pixel circuit in the present embodiment of the present disclosure comprises an electroluminescent element, a driving transistor, a first switching unit, a compensating unit, an isolating unit and a storage capacitor, wherein the first switching unit controls to input a data voltage on a data line, and a first terminal of the first switching unit is connected to a first terminal of the storage capacitor, a second terminal of the first switching unit is connected to the data line, a second terminal of the storage capacitor is connected to a gate of the driving transistor and a first terminal of the compensating unit; the compensating unit controls the storage capacitor to pre-store the threshold voltage of the driving transistor, and a second terminal of the compensating unit is connected to a drain of the driving transistor; a source of the driving transistor is connected to a power supply terminal, and the drain of the driving transistor is connected to a first terminal of an electroluminescent element; the isolating unit isolates an electrical connection between the electroluminescent element and a grounded terminal, wherein a first terminal of the isolating unit is connected to a second terminal of the electroluminescent element, a second terminal of the isolating unit is connected to the grounded terminal.

FIG. 4 shows a pixel circuit in the present embodiment of the present disclosure, wherein the pixel circuit comprises a driving transistor DTFT, a storage capacitor Cₛₜ, an OLED as the electroluminescent element, a first switching transistor T5 as the first switching unit, a compensating transistor T2 as the compensating unit, and an isolating transistor T3 as the isolating unit, and the pixel circuit further comprises a power supply terminal V_{DD}, a grounded terminal V_{SS}, a first scan signal terminal for supplying a scan signal to turn on or turn off the first switching transistor, and a data line for writing a data voltage to the pixel via the first switching transistor.

A gate of the first switching transistor T5 is connected to the first scan signal terminal, a source thereof is connected to a first terminal of the storage capacitor Cₛₜ, a drain thereof is connected to the data line, wherein the first switching transistor T5 supplies the data voltage on the data line to the storage capacitor Cₛₜ under the control of a scan signal supplied by the first scan signal terminal, and the storage capacitor Cₛₜ maintains the voltage; a second terminal of the storage capacitor Cₛₜ is connected to a gate of the driving transistor DTFT and a drain of the compensating transistor T2.

A gate of the compensating transistor T2 is connected to a first control signal terminal, a source thereof is connected to a drain of the driving transistor DTFT; a source of the driving transistor DTFT is connected to the power supply terminal V_{DD}, the drain of the driving transistor DTFT is connected to an anode of the OLED; the compensating transistor T2 is turned on under the control of a control signal supplied by the first control signal terminal, so that the gate and drain of the driving transistor DTFT are connected to form a diode connection, thus ensuring that the driving transistor DTFT is in a current saturation region; under driving of the power supply terminal V_{DD}, a threshold voltage of the driving transistor DTFT is stored in the storage capacitor Cₛₜ by a method in which the storage capacitor Cₛₜ is charged by the driving transistor DTFT, thus achieving a purpose of compensating the threshold voltage; the driving transistor DTFT is turned on or turned off under the control of a voltage stored in the storage capacitor Cₛₜ, and a current flowing through the driving transistor DTFT is controlled by the voltage stored in the storage capacitor Cₛₜ.

A gate of the isolating transistor T3 is connected to a second control signal terminal, a source thereof is connected to a cathode of the OLED, and a drain thereof is connected to the grounded terminal V_{SS}, wherein the isolating transistor T3 is turned on or turned off under the control of a control signal supplied from the second control signal terminal; when the data voltage signal on the data line is written to the pixel circuit, the isolating transistor T3 is turned off, so as to prevent the isolating transistor T3 from charging the OLED if the isolating transistor T3 is turned on, thus preventing the threshold voltage of the driving transistor DTFT pre-stored in the storage capacitor Cₛₜ from drifting and avoiding the flicker of the OLED in display.

The pixel circuit in the present embodiment of the present disclosure can further comprise a resetting transistor T6, wherein a gate of the resetting transistor T6 is connected to the source of the isolating transistor T3, a source of the resetting transistor T6 is connected to the first terminal of the storage capacitor Cₛₜ, a drain thereof is connected to the second control signal terminal. The isolating transistor T3 is firstly turned on by the control signal supplied by the second control signal terminal, so that the gate of the resetting transistor T6 is connected to the grounded terminal V_{SS}, thus the resetting transistor T6 being turned on. Since the resetting transistor T6 is turned on, voltage of the control signal EM(n) from the second control signal terminal pulls down the storage capacitor Cₛₜ, so that the driving transistor DTFT is turned on, and then the OLED is driven to emit light by the driving transistor DTFT. Meanwhile, since the resetting transistor T6 is turned on, a fixed potential is supplied to the first terminal of the storage capacitor, and the second terminal of the storage capacitor is in a float state, so that the potential at the gate of the driving transistor DTFT is clamped and thus is free of the influence of the noise, avoiding the fluctuation of the potential at the gate of the driving transistor DTFT.

The pixel circuit in the present embodiment of the present disclosure can be compatible to the data driving chip for voltage amplitude modulation, and can also be compatible to the data driving chip for pulse width modulation, and necessary voltage signals are supplied to the first scan signal terminal, the data line, the first control signal terminal and the second control signal terminal, etc. by the data driving chips.

Another advantage of the pixel circuit of the present embodiment of the present disclosure lies in that all of the transistors are of a single channel type, that is, the transistors are all P channel type transistors, thus decreasing the complexity and the production cost of the manufacturing process. Naturally, it is easy for those skilled in the art to deem that all of the transistors in the pixel circuit of the present embodiment of the present disclosure can be replaced by N channel type transistors or Complementary Metal Oxide Semiconductors CMOS; in addition, the present embodiment can be applied to an OLED display comprising OLEDs having a common anode, and is not limited to the OLED display comprising OLEDs having a common cathode, and the details are omitted.

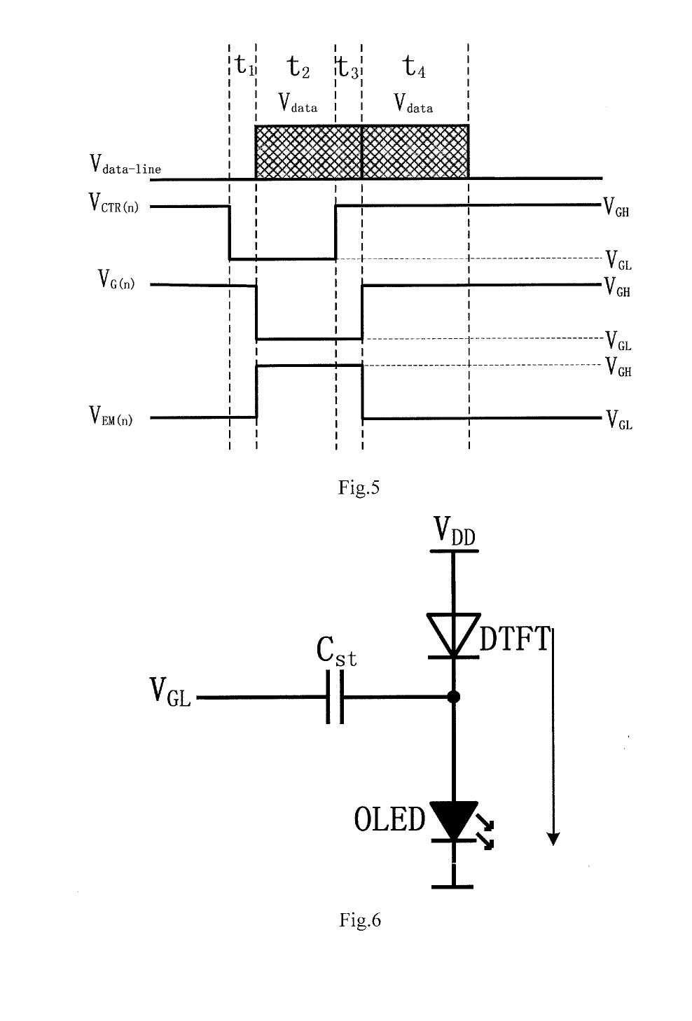

In an embodiment of the present disclosure, there is further provided a driving method for driving the pixel circuit described above. FIG. 5 shows a schematic driving timing diagram thereof. In FIG. 5, variations of the scan signal voltage G(n) at the first scan signal terminal, the data voltage V_{data} on the data line, the control signal voltage CTR(n) at the first control signal terminal, and the control signal voltage EM(n) at the second control signal terminal in one frame period are illustrated. In a period t1, that is, before the data voltage is written to the pixel circuit, the storage capacitor Cₛₜ needs to be discharged to eliminate the influence of data of the last frame. The driving method mainly comprises two periods, that is, a compensating period for compensating the threshold voltage of the driving transistor DTFT (i.e., the period t₂) and a driving and displaying period for driving the OLED to display (i.e., including the periods t₃ and t₄), wherein the data is written during the compensating period. During the period for compensating the threshold voltage of the driving transistor DTFT, under the control of a plurality of stages of voltage signals, the compensating transistor T2 and the driving transistor DTFT control the storage capacitor Cₛₜ to pre-store the threshold voltage of the driving transistor and the data voltage V_{data} on the data line, and the storage capacitor Cₛₜ maintains the threshold voltage and the data voltage V_{data} unchanged during the driving and displaying period. Hereinafter, the above periods are described in detail with reference to FIGS. 6-9.

A Resetting Period t₁:

FIG. 6 shows an equivalent circuit diagram of the pixel circuit during the period, wherein the scan signal voltage G(n) at the first scan signal terminal is at a high level, the control signal voltage CTR(n) at the first control signal terminal and the control signal voltage EM(n) at the second control signal terminal are at a low level, the resetting transistor T6, the isolating transistor T3 and the compensating transistor T2 are turned on, the first switching transistor T5 is turned off, and the gate and the drain of the driving transistor DTFT are connected to form a diode connection. The period is a resetting period for eliminating the residual voltage signals of the last period.

A Compensating Period t₂:

FIG. 7 shows an equivalent circuit diagram of the pixel circuit during the period, during the period, the OLED is in an off state, and the storage capacitor Cₛₜ pre-stores an initial voltage approximate to the threshold voltage of the driving transistor DTFT and the data voltage V_{data} on the data line. In particular, when the data voltage V_{data} is written to the pixel circuit, the scan signal voltage G(n) at the first scan signal terminal changes to a low level, and the control signal voltage CTR(n) at the first control signal terminal is maintained unchanged at a low level, so that the first switching transistor T5 and the compensating transistor T2 are in a turn-on state, the control signal voltage EM(n) at the second control signal terminal changes to a high level, the isolating transistor T3 is turned off. The data voltage V_{data} on the data line is supplied to the storage capacitor Cₛₜ, so that the potential at the node m reaches to V_{data}. Since the driving transistor DTFT is in a diode connection, it is ensured that the driving transistor DTFT operates in a current saturation region, and that a stable driving current is supplied from the power supply terminal V_{DD} via the driving transistor DTFT to charge the storage capacitor Cₛₜ, so that the potential at the drain of the driving transistor DTFT reaches V_{DD}-|V_{thd}|, at the same time, the potential at the node d is pulled up to V_{DD}−|V_{thd}|−Vₜₕₒ, wherein |V_{thd}| represents the threshold voltage of the driving transistor, and Vₜₕₒ represents the threshold voltage of the OLED; since the potential VDD is relatively higher, the potential at the node d causes the resetting transistor T6 also in a turn-off state, so as to prevent the high level signal at the second control signal terminal from entering the first terminal of the storage capacitor Cₛₜ.

An Isolating Period t3:

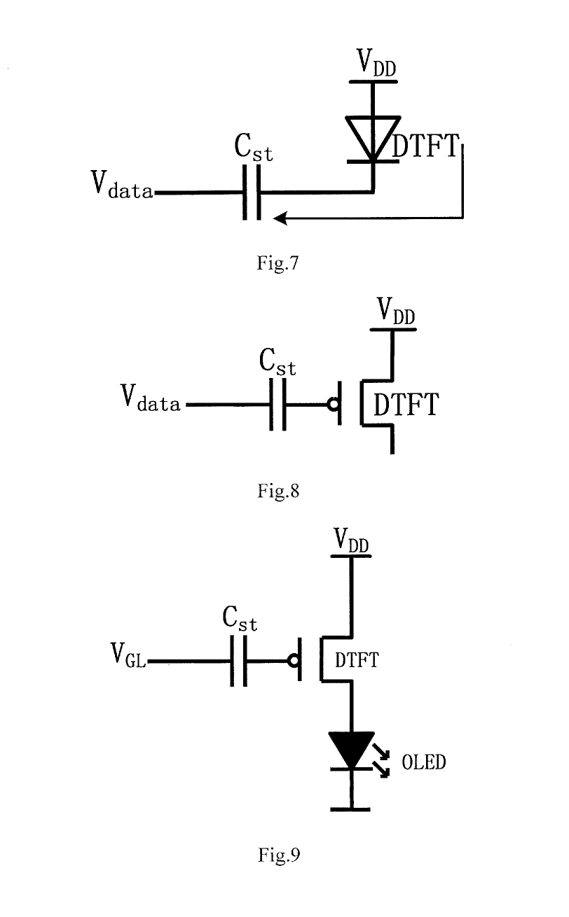

FIG. 8 shows an equivalent circuit diagram of the pixel circuit during the period, during the period, the scan signal voltage G(n) at the first scan signal terminal and the control signal voltage EM(n) at the second control signal terminal are maintained unchanged, and the control signal voltage CTR(n) at the first control signal terminal changes to a high level, the compensating transistor T2 is turned off; though the driving transistor DTFT is no longer in a diode connection, the potentials at respective nodes are maintained unchanged: at this time, the potential at the gate of the driving transistor DTFT is V_{g}=V_{DD}−|V_{thd}|, and the potential at the node m is V_{data}. The present period is an isolating period in which it is avoided that noise is input since signals are changed simultaneously. It should be understood that the isolating period t₃ is only an option in the present embodiment, and the operation therein can be performed in the following period t₄.

A Driving and Displaying Period t₄:

FIG. 9 shows an equivalent circuit diagram of the pixel circuit during the period, during the period, the OLED is in a conduction state, and the voltage stored in the storage capacitor Cₛₜ drives the OLED to display. In particular, the scan signal voltage G(n) at the first scan signal terminal changes to a high level V_{GH}, so that the first switching transistor T5 is turned off, and the control signal voltage CTR(n) at the first control signal terminal is maintained unchanged, that is, at a high level. the control signal voltage EM(n) at the second control signal terminal changes to a low level, the isolating transistor T3 and the resetting transistor T6 are in a turn-on state, so that the potential at the node m changes to a low level V_{GL}, and the OLED is in the conduction state; since the gate of the driving transistor DTFT is floated, the potential at the gate of the driving transistor DTFT also changes to V_{g}=V_{DD}−|V_{thd}|+V_{GL}−V_{data}; the gate-source voltage of the driving transistor DTFT is V_{sg}=Vₛ−V_{g}=V_{DD}−(V_{DD}−|V_{thd}|+V_{GL}−V_{data})=|V_{thd}|+V_{data}−V_{GL}; at this time, the driving transistor DTFT is in a saturation state, and supplies a stable driving current to the OLED, and the driving current for the OLED is

I_{oled}=K(V_{sg}−|V_{thd}|)²=K(|V_{thd}|+V_{data}−V_{GL}−|V_{thd}|)²=K(V_{data}−V_{GL})²

wherein K represents a constant related to the technical process and the design of the driving circuit.

It can be seen that the driving current I_{oled} is independent of the threshold voltage of the driving transistor DTFT, and thus the drift of the threshold voltage of the driving transistor DTFT has no influence on the current of the drain of the driving transistor DTFT (i.e., the driving current I_{oled} of the pixel circuit); meanwhile, the formula for the current of the circuit does not contain the term of power supply voltage (V_{DD} or V_{SS}), thus removing the influence of the internal resistance on the light-emitting current, so that the OLED operates stably in display, and thus the display quality is greatly improved.

### Second Embodiment

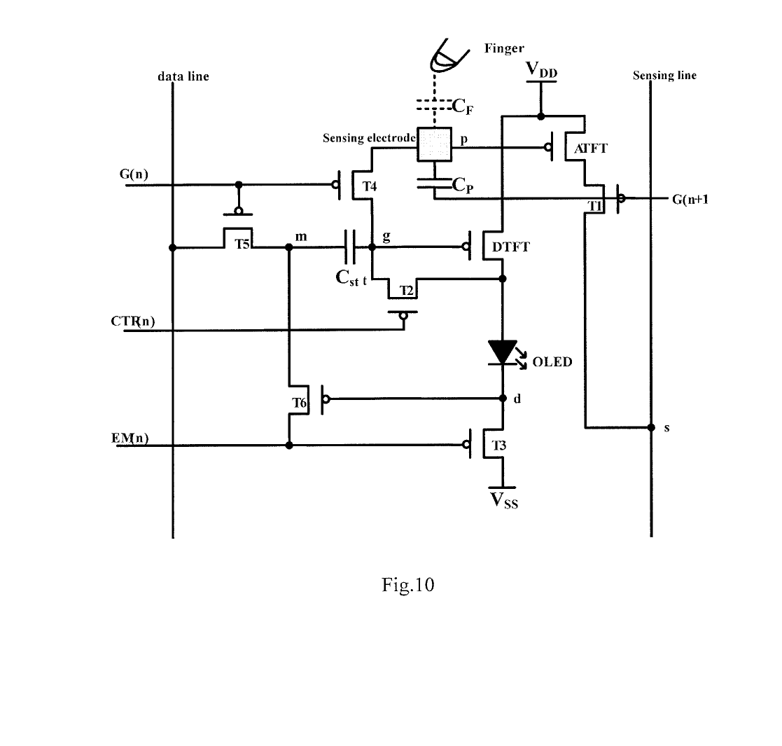

In the embodiment of the present disclosure, a touch circuit is further integrated into the pixel circuit perfectly. Now, detailed descriptions are given to the present embodiment on the basis of the pixel circuit illustrated in the first embodiment of the present disclosure. FIG. 10 illustrates a pixel circuit according to the second embodiment of the present disclosure, wherein, besides an OLED, a driving transistor DTFF, a first switching transistor T5, a compensating transistor T2, an isolating transistor T3, a resetting transistor T6 and a storage capacitor Cₛₜ, the pixel circuit further comprises an integrated touch circuit. The touch circuit comprises a charging transistor T4, a coupling capacitor C_{P}, a sensing electrode, an amplifying transistor ATFT and a second switching transistor T1; wherein a gate of the charging transistor T4 is connected to a third control signal terminal, a source thereof is connected to a second terminal of the storage capacitor Cₛₜ, a drain thereof is connected to the sensing electrode; under the control of a control signal supplied from the third control signal terminal, the charging transistor T4 is turned on; while the power supply terminal V_{DD} charges the storage capacitor Cₛₜ, a driving voltage is supplied to the coupling capacitor Cₚ and is held in the coupling capacitor Cₚ; a first terminal of the coupling capacitor Cₚ is connected to the sensing electrode, and a second terminal thereof is connected to the second scan signal terminal; a gate of the amplifying transistor ATFT is connected to the sensing electrode, a source thereof is connected to the power supply terminal V_{DD}, a drain thereof is connected to the source of the second switching transistor T1, and the amplifying transistor ATFT is mainly used for amplifying a touch signal of a finger; a gate of the second switching transistor T1 is connected to the second scan signal terminal, a drain thereof is connected to a sensing line, and under the control of the scan signal supplied from the second scan signal terminal, the second switching transistor T1 is turned on and transmits the amplified touch signal to the sensing line; then information on the touch can be obtained by detecting variation of signal on the sensing line. Further, in order to simplify the technical process and reduce the cost, the third control signal terminal can be the first scan signal terminal; by multiplexing the scan signal in the pixel circuit to charge the coupling capacitor Cₚ in the touch circuit, the integration of the touch circuit into the pixel circuit can be realized perfectly without increasing the complexity of the circuit structure and the operation thereof. Also, in the data driving chip of the pixel circuit in the present embodiment, it is unnecessary to arrange a special control signal driving portion for the touch circuit, thus simplifying the circuit structure and the technical process flow.

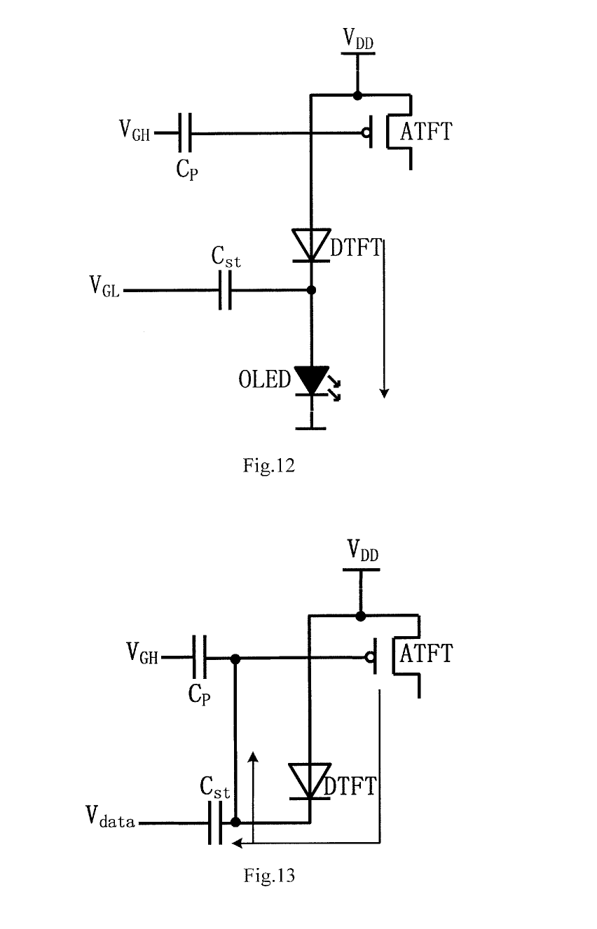

In the embodiment of the present disclosure, there is further provided a driving method for driving the pixel circuit described above. FIG. 10 shows a schematic driving timing diagram thereof. In FIG. 10, variations of the scan signal voltage G(n) at the first scan signal terminal, the scan signal voltage G(n+1) at the second scan signal terminal, the data voltage V_{data} on the data line, the control signal voltage CTR(n) at the first control signal terminal, and the control signal voltage EM(n) at the second control signal terminal in one frame period are illustrated. Hereinafter, the above periods are described in detail with reference to FIGS. 12-15.

A Resetting Period t₁:

FIG. 12 shows an equivalent circuit diagram of the pixel circuit during the period, wherein during the period t₁, the scan signal voltage G(n) at the first scan signal terminal and the scan signal voltage G(n+1) at the second scan signal terminal are at a high level, the control signal voltage CTR(n) at the first control signal terminal and the control signal voltage EM(n) at the second control signal terminal are at a low level, the resetting transistor T6, the isolating transistor T3 and the compensating transistor T2 are turned on, the first switching transistor T5, the charging transistor T4 and the second switching transistor T1 are turned off, and the gate and the drain of the driving transistor DTFT are connected to form a diode connection, and the drain of the amplifying transistor ATFT is in an open-circuit state. The period is a resetting period for eliminating the residual voltage signals of the last period.

A Compensating Period t₂:

FIG. 13 shows an equivalent circuit diagram of the pixel circuit during the period, during the period, the OLED is in a turn-off state, and the storage capacitor Cₛₜ pre-stores an initial voltage approximate to the threshold voltage of the driving transistor DTFT and the data voltage V_{data} on the data line; at the same time, the coupling capacitor Cₚ is charged. In particular, when the data voltage V_{data} is written to the pixel, the scan signal voltage G(n) at the first scan signal terminal changes to a low level, the first switching transistor T5 and the charging transistor T4 are in a turn-on state; the scan signal voltage G(n+1) at the second scan signal terminal is maintained unchanged at a high level, the control signal voltage CTR(n) at the first control signal terminal is maintained unchanged at a low level, so that the first switching transistor T5 and the compensating transistor T2 are in a turn-on state, the control signal voltage EM(n) at the second control signal terminal changes to a high level, the isolating transistor T3 is turned off. The data voltage V_{data} on the data line is supplied to the storage capacitor Cₛₜ, so that the potential at the node m reaches to V_{data}. Since the driving transistor DTFT is in a diode connection, it is ensured that the driving transistor DTFT operates in a current saturation region, and that the a stable driving current is supplied from the power supply terminal V_{DD} via the driving transistor DTFT to charge the storage capacitor Cₛₜ, so that the potential at the drain of the driving transistor DTFT reaches V_{DD}−|V_{thd}|, and the potential at the node p is also charged to V_{DD}−|V_{thd}|; at the same time, the potential at the node d is pulled up to V_{DD}−|V_{thd}|−Vₜₕₒ, wherein |V_{thd}| represents the threshold voltage of the driving transistor, and Vₜₕₒ represents the threshold voltage of the OLED; since the potential VDD is relatively higher, the potential at the node d causes the resetting transistor T6 also in a turn-off state, so as to prevent the high level signal at the second control signal terminal from entering the first terminal of the storage capacitor Cₛₜ.

An Isolating Period t3:

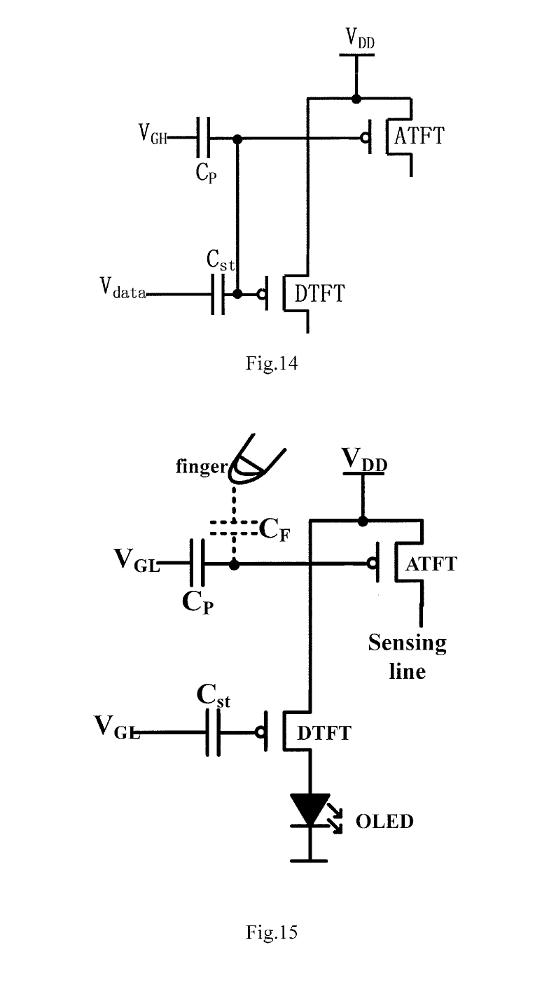

FIG. 14 shows an equivalent circuit diagram of the pixel circuit during the period, during the period, the scan signal voltage G(n) at the first scan signal terminal, the scan signal voltage G(n+1) at the second scan signal terminal and the control signal voltage EM(n) at the second control signal terminal are maintained unchanged, and the control signal voltage CTR(n) at the first control signal terminal changes to a high level, the compensating transistor T2 is turned off; though the driving transistor DTFT is no longer in a diode connection, the potentials at respective nodes are maintained unchanged: at this time, the potential at the gate of the driving transistor DTFT is V_{g}=V_{DD}−|V_{thd}|, and the potential at the node m is V_{data}, the potential at the node p is V_{DD}−|V_{thd}|. The present period is an isolating period in which it is avoided that noise is input since signals are changed simultaneously. It should be understood that the isolating period t₃ is only an option in the embodiment, and the operation therein can be performed in the following period t₄.

A Driving and Displaying Period t₄:

FIG. 15 shows an equivalent circuit diagram of the pixel circuit during the period, during the period, the OLED is in a conduction state, and the voltage stored in the storage capacitor Cₛₜ drives the OLED to display. The amplified touch signal is transmitted to the sensing line, and the information on the touch is obtained by monitoring the variation of the signal on the sensing line. In particular, the scan signal voltage G(n) at the first scan signal terminal changes to a high level, so that the first switching transistor T5 is turned off, the scan signal voltage G(n+1) at the second scan signal terminal changes to a low level, so that the second switching transistor T1 is in a turn-on state; the control signal voltage CTR(n) at the first control signal terminal is maintained unchanged at a high level, the control signal voltage EM(n) at the second control signal terminal changes to a low level, the isolating transistor T3 and the resetting transistor T6 are in a turn-on state, so that the potential at the node m changes to a low level V_{GL}, and the OLED is in the conduction state; since the gate of the driving transistor DTFT is floated, the potential at the gate of the driving transistor DTFT also changes to V_{g}=V_{DD}−|V_{thd}|+V_{GL}−V_{data}; the gate-source voltage of the driving transistor DTFT is V_{sg}=Vₛ−V_{g}=V_{DD}−(V_{DD}−|V_{thd}|+V_{GL}−V_{data})=|V_{thd}|+V_{data}−V_{GL}; at this time, the driving transistor DTFT is in a saturation state, and supplies a stable driving current to the OLED, and the driving current for the OLED is

I_{oled}=K(V_{sg}−|V_{thd}|)²=K(|V_{thd}|+V_{data}−V_{GL}−|V_{thd}|)²=K(V_{data}−V_{GL})²,

wherein K represents a constant related to the technical process and the design of the driving circuit.

It can be seen that the driving current I_{oled} is independent of the threshold voltage of the driving transistor DTFT, and thus the drift of the threshold voltage of the driving transistor DTFT has no influence on the current of the drain of the driving transistor DTFT (i.e., the driving current I_{oled} of the pixel circuit); meanwhile, in the pixel circuit, the influence of the internal resistance on the light-emitting current is removed, achieving the stable display and flickerless of the OLED, and thus greatly improving the display quality.

Since the scan signal voltage G(n+1) at the second scan signal terminal changes downward, the gate of the amplified transistor ATFT is floated, and the potential at the node p is pulled down simultaneously. How much the potential at the node p changes downward depends on two cases: a case in which there is a finger touch and another case in which there is no any finger touch. In the case wherein there is a finger touch, since a sensing capacitor C_{F} is formed between the finger and the sensing electrode, and thus the potential at the node p is Vₚ=V_{DD}−|V_{thd}|+(V_{GL}−V_{GH})×Cₚ/(Cₚ+C_{F}).

The gate-source voltage of the amplifying transistor ATFT is

$$\begin{matrix}{V}_{sg} = {V}_{s} - {V}_{g} \\ = {V}_{DD} - [ {V}_{DD} - \vert {V}_{thd} \vert + ( {V}_{GL} - {V}_{GH} ) \times {C}_{p} / ( {C}_{p} + {C}_{F} ) ] \\ = \vert {V}_{thd} \vert + ( {V}_{GH} - {V}_{GL} ) \times {C}_{p} / ( {C}_{p} + {C}_{F} ) .\end{matrix}$$

Therefore, the sensing current flowing through the sensing line is

$$\begin{matrix}{I}_{se} = {{K}_{a} ( {V}_{sg} - \vert {V}_{tha} \vert )}^{2} \\ = {{K}_{a} ( {V}_{sg} - \vert {V}_{tha} \vert )}^{2} \\ = {{K}_{a} [ \vert {V}_{thd} \vert + ( {V}_{GH} - {V}_{GL} ) \times {C}_{p} / ( {C}_{p} + {C}_{F} ) - \vert {V}_{tha} \vert ]}^{2} .\end{matrix}$$

wherein Vₜₕ represents the threshold voltage of the driving transistor, Vₜₕₐ represents the threshold voltage of the amplifying transistor ATFT, and Kₐ represents a constant related to the technical process and design of the amplifying transistor ATFT.

In the case where there is no any finger touch, the potential at the node p is Vₚ=V_{DD}−|V_{thd}|−(V_{GH}−V_{GL}).

The gate-source voltage of the amplifying transistor ATFT is

$$\begin{matrix}{V}_{sg} = {V}_{s} - {V}_{g} \\ = {V}_{DD} - [ {V}_{DD} - \vert {V}_{thd} \vert - ( {V}_{GH} - {V}_{GL} ) ] \\ = \vert {V}_{thd} \vert + {V}_{GH} - {V}_{GL} .\end{matrix}$$

The sensing current flowing through the sensing line is

$$\begin{matrix}{I}_{se} = {{K}_{a} ( {V}_{sg} - \vert {V}_{tha} \vert )}^{2} \\ = {{K}_{a} ( {V}_{sg} - \vert {V}_{tha} \vert )}^{2} \\ = {{K}_{a} [ \vert {V}_{thd} \vert + ( {V}_{GH} - {V}_{GL} ) - \vert {V}_{tha} \vert ]}^{2} .\end{matrix}$$

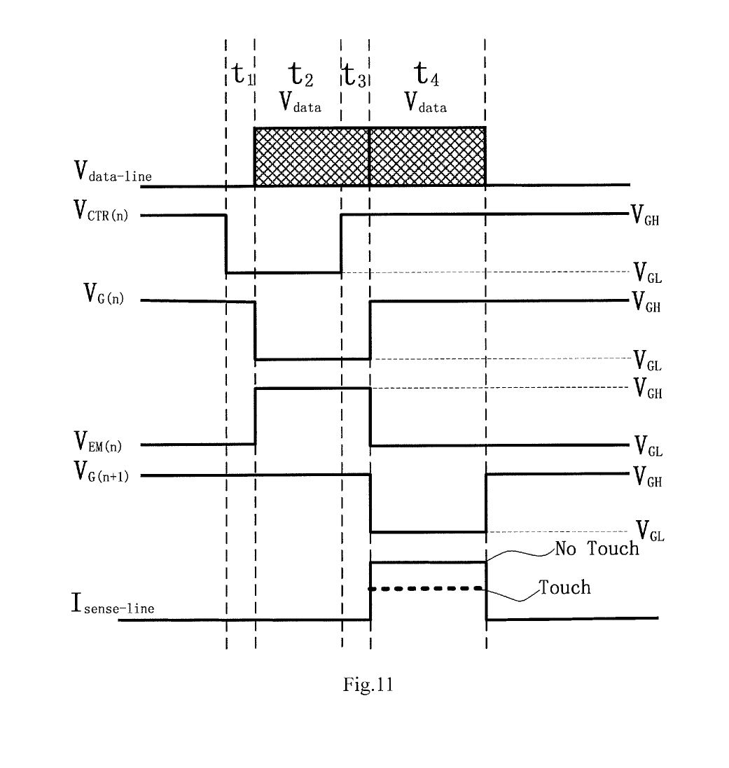

Therefore, it can be determined that whether there is a finger touch at a certain location by monitoring the current on the sensing line, and the FIG. 11 shows the current difference Iₛₑₙₛₑ₋ₗᵢₙₑ due to the touch.

The operations on the driving for one row of pixels to emit light and on determination of the touch on the row of pixels are realized during the above periods, and the touch circuit is integrated into the pixel circuit perfectly without increasing the complexity of the circuit structure and the operation of thereof.

### Third Embodiment

In the embodiment of the present disclosure, there is provided a display device comprising the above pixel circuit. In particular, the display device comprises a plurality of pixel units each corresponding to any of the pixel circuits described as above. Since the pixel circuit can compensate the drift of the threshold voltage of the driving transistor, the OLED operates stably in display and does not flicker, thus ensuring that the display quality of the display device adopting OLED. Meanwhile, in the embodiments of the present disclosure, the control signal for the pixel circuit is multiplexed in the touch circuit, and the coupling capacitor is charged in the touch circuit via the charging transistor while the storage capacitor is charged, thus realizing the integration of the touch circuit into the pixel circuit perfectly; and by combining the display function and the touch function together, only one technical process flow rather than two separate technical process flows is necessary, thus the embodiments of the present disclosure not only has an advantage of low cost, but also makes the technical process simple and the display device more lighter and thinner.

The aforesaid only illustrates some embodiments of the present disclosure, and it should be noted that a number of modifications and variations can be made to the embodiments of the present disclosure by those skilled in the art without departing from the spirit and principle of the present invention, and such modifications and variation should be regarded as falling into the protection scope of the present invention.

1-10. (canceled)

11. A pixel circuit, characterized by comprising an electroluminescent element, a driving transistor, a first switching unit, a compensating unit, an isolating unit and a storage capacitor, wherein
the first switching unit controls input of a data voltage on a data line, and a first terminal of the first switching unit is connected to a first terminal of the storage capacitor, a second terminal of the first switching unit is connected to the data line;
a second terminal of the storage capacitor is connected to a gate of the driving transistor and a first terminal of the compensating unit;
the compensating unit controls the storage capacitor to pre-store a threshold voltage of the driving transistor, and a second terminal of the compensating unit is connected to a drain of the driving transistor;
a source of the driving transistor is connected to a power supply terminal, the drain of the driving transistor is connected to a first terminal of the electroluminescent element; and
the isolating unit isolates an electrical connection between the electroluminescent element and a grounded terminal, wherein a first terminal of the isolating unit is connected to a second terminal of the electroluminescent element, and a second terminal of the isolating unit is connected to the grounded terminal.

12. The pixel circuit of claim 11, characterized in that the electroluminescent element is an Organic Light Emitting Diode, the first switching unit is a first switching transistor, the compensating unit is a compensating transistor, and the isolating unit is an isolating transistor;
a gate of the first switching transistor is connected to a first scan signal terminal, a source thereof is connected to the first terminal of the storage capacitor, a drain thereof is connected to the data line;
the second terminal of the storage capacitor is connected to the gate of the driving transistor and a drain of the compensating transistor;
a gate of the compensating transistor is connected to a first control signal terminal, a source thereof is connected to the drain of the driving transistor;
the source of the driving transistor is connected to the power supply terminal, the drain of the driving transistor is connected to an anode of the OLED; and
a gate of the isolating transistor is connected to a second control signal terminal, a source thereof is connected to a cathode of the OLED, and a drain thereof is connected to the grounded terminal.

13. The pixel circuit of claim 12, characterized by further comprising a resetting transistor, wherein a gate of the resetting transistor is connected to the source of the isolating transistor, a source of the resetting transistor is connected to the first terminal of the storage capacitor, and a drain thereof is connected to the second control signal terminal.

14. The pixel circuit of claim 12, characterized in that the pixel circuit is further connected to a touch circuit, wherein the touch circuit comprises a charging transistor, a coupling capacitor, a sensing electrode, an amplifying transistor and a second switching transistor, a second scan signal terminal and a sensing line;
wherein a gate of the charging transistor is connected to a third control signal terminal, a source thereof is connected to the second terminal of the storage capacitor, a drain thereof is connected to the sensing electrode;
a first terminal of the coupling capacitor is connected to the sensing electrode, and a second terminal thereof is connected to the second scan signal terminal;
a gate of the amplifying transistor is connected to the sensing electrode, a source thereof is connected to the power supply terminal, a drain thereof is connected to the source of the second switching transistor; and
a gate of the second switching transistor is connected to the second scan signal terminal, and a drain thereof is connected to the sensing line.

15. The pixel circuit of claim 13, characterized in that the pixel circuit is further connected to a touch circuit, wherein the touch circuit comprises a charging transistor, a coupling capacitor, a sensing electrode, an amplifying transistor and a second switching transistor, a second scan signal terminal and a sensing line;
wherein a gate of the charging transistor is connected to a third control signal terminal, a source thereof is connected to the second terminal of the storage capacitor, a drain thereof is connected to the sensing electrode;
a first terminal of the coupling capacitor is connected to the sensing electrode, and a second terminal thereof is connected to the second scan signal terminal;
a gate of the amplifying transistor is connected to the sensing electrode, a source thereof is connected to the power supply terminal, a drain thereof is connected to the source of the second switching transistor; and
a gate of the second switching transistor is connected to the second scan signal terminal, and a drain thereof is connected to the sensing line.

16. The pixel circuit of claim 14, characterized in that the third control signal terminal is the first scan signal terminal.

17. The pixel circuit of claim 15, characterized in that the third control signal terminal is the first scan signal terminal.

18. The pixel circuit of claim 12, characterized in that all the transistors have a same type of channel.

19. A driving method for the pixel circuit of claim 12, characterized by comprising steps of:
S1, applying a scan signal at the first scan signal terminal and applying a control signal at the first control signal terminal to turn on the first switching transistor and the compensating transistor, and applying a control signal at the second control signal terminal to turn off the isolating transistor, so as to write the threshold voltage of the driving transistor and the data voltage on the data line to the storage capacitor; and
S2, applying a scan signal at the first scan signal terminal and applying a control signal at the first control signal terminal to turn off the first switching transistor and the compensating transistor, and applying a control signal at the second control signal terminal to turn on the isolating transistor, so as to drive the OLED to emit light using the voltage stored in the storage capacitor.

20. The driving method of claim 19, wherein the pixel circuit further comprises a resetting transistor, wherein a gate of the resetting transistor is connected to the source of the isolating transistor, a source of the resetting transistor is connected to the first terminal of the storage capacitor, and a drain thereof is connected to the second control signal terminal,
the driving method is characterized by, prior to the step S1, further comprising:
applying a scan signal at the first scan signal terminal to turn off the first switching transistor, applying control signals at the first control signal terminal and the second control signal terminal respectively to turn on the compensating transistor, the isolating transistor, and the resetting transistor so as to reset the storage capacitor.

21. The driving method of claim 19, wherein the pixel circuit is further connected to a touch circuit, wherein the touch circuit comprises a charging transistor, a coupling capacitor, a sensing electrode, an amplifying transistor and a second switching transistor, a second scan signal terminal and a sensing line;
wherein a gate of the charging transistor is connected to a third control signal terminal, a source thereof is connected to the second terminal of the storage capacitor, a drain thereof is connected to the sensing electrode; a first terminal of the coupling capacitor is connected to the sensing electrode, and a second terminal thereof is connected to the second scan signal terminal; a gate of the amplifying transistor is connected to the sensing electrode, a source thereof is connected to the power supply terminal, a drain thereof is connected to the source of the second switching transistor; and a gate of the second switching transistor is connected to the second scan signal terminal, and a drain thereof is connected to the sensing line,
characterized in that,
the step S1 further comprises: applying a scan signal at the first scan signal terminal to turn on the charging transistor, and applying a scan signal at the second scan signal terminal to turn off the second switching transistor, so as to charge the coupling capacitor by the power supply terminal via the driving transistor and the charging transistor; and
the step S2 further comprises: applying a scan signal at the first scan signal terminal to turn off the charging transistor, applying a scan signal at the second scan signal terminal to turn on the second switching transistor, and monitoring a variation of a current on the sensing line.

22. The driving method of claim 20, wherein the pixel circuit is further connected to a touch circuit, wherein the touch circuit comprises a charging transistor, a coupling capacitor, a sensing electrode, an amplifying transistor and a second switching transistor, a second scan signal terminal and a sensing line;
wherein a gate of the charging transistor is connected to a third control signal terminal, a source thereof is connected to the second terminal of the storage capacitor, a drain thereof is connected to the sensing electrode; a first terminal of the coupling capacitor is connected to the sensing electrode, and a second terminal thereof is connected to the second scan signal terminal; a gate of the amplifying transistor is connected to the sensing electrode, a source thereof is connected to the power supply terminal, a drain thereof is connected to the source of the second switching transistor; and a gate of the second switching transistor is connected to the second scan signal terminal, and a drain thereof is connected to the sensing line,
characterized in that,
the step S1 further comprises: applying a scan signal at the first scan signal terminal to turn on the charging transistor, and applying a scan signal at the second scan signal terminal to turn off the second switching transistor, so as to charge the coupling capacitor by the power supply terminal via the driving transistor and the charging transistor; and
the step S2 further comprises: applying a scan signal at the first scan signal terminal to turn off the charging transistor, applying a scan signal at the second scan signal terminal to turn on the second switching transistor, and monitoring a variation of a current on the sensing line.

23. A display device comprising the pixel circuit of claim 11.

24. The display device of claim 23, characterized in that the electroluminescent element is an Organic Light Emitting Diode, the first switching unit is a first switching transistor, the compensating unit is a compensating transistor, and the isolating unit is an isolating transistor;
a gate of the first switching transistor is connected to a first scan signal terminal, a source thereof is connected to the first terminal of the storage capacitor, a drain thereof is connected to the data line;
the second terminal of the storage capacitor is connected to the gate of the driving transistor and a drain of the compensating transistor;
a gate of the compensating transistor is connected to a first control signal terminal, a source thereof is connected to the drain of the driving transistor;
the source of the driving transistor is connected to the power supply terminal, the drain of the driving transistor is connected to an anode of the OLED; and
a gate of the isolating transistor is connected to a second control signal terminal, a source thereof is connected to a cathode of the OLED, and a drain thereof is connected to the grounded terminal.

25. The display device of claim 24, characterized in that the pixel circuit further comprises a resetting transistor, wherein a gate of the resetting transistor is connected to the source of the isolating transistor, a source of the resetting transistor is connected to the first terminal of the storage capacitor, and a drain thereof is connected to the second control signal terminal.

26. The display device of claim 24, characterized in that the pixel circuit is further connected to a touch circuit, wherein the touch circuit comprises a charging transistor, a coupling capacitor, a sensing electrode, an amplifying transistor and a second switching transistor, a second scan signal terminal and a sensing line;
wherein a gate of the charging transistor is connected to a third control signal terminal, a source thereof is connected to the second terminal of the storage capacitor, a drain thereof is connected to the sensing electrode;
a first terminal of the coupling capacitor is connected to the sensing electrode, and a second terminal thereof is connected to the second scan signal terminal;
a gate of the amplifying transistor is connected to the sensing electrode, a source thereof is connected to the power supply terminal, a drain thereof is connected to the source of the second switching transistor; and
a gate of the second switching transistor is connected to the second scan signal terminal, and a drain thereof is connected to the sensing line.

27. The display device of claim 25, characterized in that the pixel circuit is further connected to a touch circuit, wherein the touch circuit comprises a charging transistor, a coupling capacitor, a sensing electrode, an amplifying transistor and a second switching transistor, a second scan signal terminal and a sensing line;
wherein a gate of the charging transistor is connected to a third control signal terminal, a source thereof is connected to the second terminal of the storage capacitor, a drain thereof is connected to the sensing electrode;
a first terminal of the coupling capacitor is connected to the sensing electrode, and a second terminal thereof is connected to the second scan signal terminal;
a gate of the amplifying transistor is connected to the sensing electrode, a source thereof is connected to the power supply terminal, a drain thereof is connected to the source of the second switching transistor; and
a gate of the second switching transistor is connected to the second scan signal terminal, and a drain thereof is connected to the sensing line.

28. The display device of claim 26, characterized in that the third control signal terminal is the first scan signal terminal.

29. The display device of claim 27, characterized in that the third control signal terminal is the first scan signal terminal.

30. The display device of claim 24, characterized in that all the transistors have a same type of channel.
